(19) United States
(12) Patent Application Publication
(10) Pub. No.: US 2025/0205783 A1
(43) Pub. Date: Jun. 26, 2025

(54) ADDITIVE MANUFACTURING DEVICE COMPRISING A ROBOT FOR CHARACTERIZING PROTECTIVE GAS FLOWS

(71) Applicant: L'Air Liquide, Societe Anonyme pour l'Etude et l’Exploitation des Procedes Georges Claude, Paris (FR)

(72) Inventors: Philippe LEFEBVRE, Jouy-en-Josas (FR); Quentin MANDOU, Jouy-en-Josas (FR)

(21) Appl. No.: 18/849,373

(22) PCT Filed: Feb. 2, 2023
(86) PCT No.: PCT/EP2023/052593

§ 371 Date: Sep. 20, 2024

(30) Foreign Application Priority Data
Mar. 22, 2022 (FR) FR 2202540

(51) Int. Cl. B22F 10/322; B22F 12/90; B25J 9/02; B25J 9/08; B33Y 30/00; B33Y 40/00

(52) U.S. Cl. CPC B22F 10/322; B22F 12/90; B25J 9/026; B25J 9/08; B33Y 30/00; B33Y 40/00

(57) ABSTRACT

A device for the additive manufacturing of at least one part having a manufacturing chamber which includes, in its internal space, a manufacturing region, an irradiating means configured to irradiate at least one portion of the manufacturing region corresponding to a cross-section of the part, a gas supply system connected to the internal space of the manufacturing chamber and configured to produce a gas flow for protecting the manufacturing region when the manufacturing chamber is supplied with gas, an adjustable robot configured to utilize at least one portion of the protective gas flow, the adjustable robot comprising a measurement arm, a first frame carrying the measurement arm, a first movement arm associated with the first frame and extending parallel to a first direction, first drive means for driving the first frame, capable of causing the first frame to move in translation along the first movement arm, a second frame.

### CROSS-REFERENCE TO RELATED APPLICATIONS

This application is a § 371 of International PCT Application PCT/EP20203/052593, filed Feb. 2, 2023, which claims § 119(a) foreign priority to French patent application FR 2202540, filed Mar. 22, 2022.

### BACKGROUND

### Field of the Invention

The present invention relates to an additive manufacturing device comprising a robot dedicated to the control of shielding gas flows generated in a manufacturing enclosure of said manufacturing device.

In particular, the invention is applicable in an additive manufacturing device intended for the implementation of a metal powder bed laser-fusion additive manufacturing process.

### Related Art

Additive manufacturing combines processes for manufacturing parts in three dimensions by successive addition of layers of material, on the basis of a digital model, without the use of tooling. The term “additive” is used in contrast to traditional methods, such as machining, which are based on a removal of material.

Additive manufacturing methods, also referred to as 3D printing methods, such as in particular selective laser melting, selective laser sintering, stereolithography and the like, are understood to be methods in which a three-dimensional component is produced from base materials by means of chemical and/or physical operations. The base material is generally liquefied or melted at least region by region, in order to harden it with a view to forming the part to be manufactured.

Known in particular are processes utilizing a laser beam and a base material in the form of powder, the material being melted locally, and layer by layer, by having the laser selectively sweep the powder bed according to a preset digital model. The expression powder bed laser fusion is also used. Fusion processes cause the base material to be heated to a temperature above the melting temperature. When the laser beam interacts with the powder bed, a column of metal vapor referred to as keyhole, as can be found in laser welding processes, is formed in the region melted by the beam. Owing to the expansion of the metal vapor toward the outside of the keyhole, fumes and metal spatter extracted from the powder bed and from the pool of molten metal are generated.

However, the metal spatter contains oxides, and the melting of oxides while parts are being manufactured by additive manufacturing can create manufacturing defects within the part, such as visual defects, metallurgical defects, density defects and/or porosity defects.

In order to control the properties and the quality of the manufactured parts, it is known to carry out additive manufacturing processes in additive manufacturing chambers. These chambers are closed enclosures in which the gaseous atmosphere is controlled. The manufacturing enclosures are provided with a shielding-gas supply system connected to the internal volume of the manufacturing chamber in order to produce there a gas flow for protecting the manufacturing area from oxidation, fumes and spatter impacts.

The homogeneity of the gas flow within the additive manufacturing chambers makes it possible to ensure the quality of the parts produced, notably for alloys that give off a lot of fumes or for the production of large parts, which requires a production time of several hours or even several days.

However, it is known that the gas flows generated in the additive manufacturing chambers are not, or are not very homogeneous, and information about the inhomogeneity of the shielding gas flows is generally not available.

As a matter of fact, the lack of homogeneity of the blanket of shielding gas can cause the discharge of fumes and spatter at the interaction zone to be less effective. These phenomena have been described in multiple publications, including the article titled “Influence of the shielding gas flow on the removal of process by-products in the selective laser melting process”, by A. Ladewig et al. (Additive Manufacturing, vol. 10, 2016, pp. 1-9) and the article titled “Gas flow effects on selective laser melting (SLM) manufacturing performance”, by B. Ferrar et al. (Journal of Materials Processing Technology vol. 212, 2012, pp. 355-364).

There are systems for mapping the gas flows generated in additive manufacturing chambers, such as that described in the publication titled “A study into the effects of gas flow inlet design of the renishaw am250 laser powder bed fusion machine using computational modelling”, by A. M. Philo (Solid Freeform Fabrication 2017: Proceedings of the 28^{th} Annual International Solid Freeform Fabrication Symposium, pages 1203 to 1219). These systems are generally equipped with a probe for measuring the velocity of the flows. In general, these systems have a probe supported by a robot which is able to move within the flow generated above the manufacturing area.

However, these robots are constructed on the basis of the dimensions of the chamber and of the manufacturing area and are not modular. These dimensions vary from one additive manufacturing machine manufacturer to the next and also vary according to the applications intended by the users and the dimensions of the parts to be produced. The characterization of the gas flows thus requires construction of a measuring robot dedicated to each existing chamber configuration, and this complicates the installation of the characterization system.

Furthermore, the movements that are possible in the volume of the additive manufacturing chamber can be limited, resulting in incomplete or imprecise mapping of the gas flows.

### SUMMARY OF THE INVENTION

An aim of the present invention is to overcome the drawbacks described above, in particular to propose an additive manufacturing device provided with a robot for characterizing the shielding gas flows, wherein the robot can be easily adapted to the dimensions of the manufacturing chamber.

A solution according to the present invention is then a device for additively manufacturing at least one part, comprising:
a manufacturing chamber comprising a manufacturing area in its internal volume,
an irradiation means configured to irradiate at least part of the manufacturing area corresponding to a cross section of said part,
a gas supply system connected to the internal volume of the manufacturing chamber and configured to generate a shielding gas flow for the manufacturing area when gas is supplied to the manufacturing chamber,
a modular robot configured to characterize at least one portion of the shielding gas flow, said modular robot comprising:
   a measuring arm comprising at least one measuring probe configured to measure at least one physical variable characteristic of the gas flow,
   a first chassis supporting the measuring arm,
   a first movement arm associated with the first chassis and extending parallel to a first direction,
   first drive means for the first chassis that are able to make the first chassis move in translation along the first movement arm,
   a second chassis to which the first movement arm is secured,
   a second movement arm associated with the second chassis and extending parallel to a second direction,
   second drive means for the second chassis that are able to make the second chassis and the first movement arm move in translation along the second movement arm, characterized in that at least one of the first movement arm and the second movement arm of the modular robot comprises multiple physically separate modules joined to one another by removable joining means such that the total length of the first movement arm and/or the total length of the second movement arm can be adjusted by removing or adding one or more modules.

Depending on the case, the invention may comprise one or more of the features set out below.
the first direction is orthogonal to the second direction.
the modular robot comprises third drive means for the measuring arm that are secured to the first chassis, the third drive means being able to make the measuring arm move in translation parallel to a third direction orthogonal to the first direction.
the modular robot additionally comprises a third chassis and a third movement arm associated with the third chassis, the third movement arm extending parallel to the second movement arm, the first movement arm being secured to the third chassis, the modular robot comprising fourth drive means for the third chassis (110) that are able to make the third chassis move in translation along the third movement arm and means for synchronizing the second drive means and fourth drive means that are configured to synchronize the translational movement of the second chassis and of the third chassis.
the modular robot comprises fifth drive means that are able to make the second chassis rotate about the second arm or to make the second arm rotate on itself.
the robot comprises angular adjustment means that are configured to adjust the positioning of the measuring probe by way of pivoting on the first movement arm and/or by way of rotation about the first movement arm.
the removable joining means for joining one module to another comprise at least one intermediate part and securing means for securing said intermediate part to both one module and the other module.
the removable joining means are configured to join one module to another by push-fitting and/or by way of a magnetic connection.
each of the first, second and/or third movement arms and/or the measuring arm of the modular robot comprises from 2 to 40 modules, preferably from 2 to 10 modules.
the modules forming the first, second and/or third movement arms and/or the measuring arm of the modular robot have lengths ranging between 25 and 500 mm.
each of the first, second, third, fourth and/or fifth drive means comprises a motor interacting with a rack-and-pinion drive system, the one or more movement arms having a toothed surface intended to mesh with a toothed pinion, or a friction drive system comprising a pinion coated with a deformable material frictionally interacting with the one or more movement arms.
the measuring probe is configured to measure a volumetric flow rate and/or velocity of the gas flow, in particular the measuring probe comprises a Pitot tube or a hot wire system.
the measuring arm comprises at least one additional measuring probe configured to measure a temperature of and/or an oxygen content in the gas flow or the measuring probe is configured to measure a temperature of and/or an oxygen content in the gas flow.
The device is configured for powder-bed laser fusion additive manufacturing, the device comprising:
   a manufacturing platform configured to receive the base material in the form of a layer of metal powder, a manufacturing direction z in which the layers of base material are deposited and melted in succession,
   spreading means for spreading said layer so as to form a powder bed extending in a plane orthogonal to a manufacturing direction,
   at least one laser source configured to irradiate and selectively melt the powder bed in the manufacturing area corresponding to a cross section of the metal part,
   means for moving the manufacturing platform parallel to the manufacturing direction.

According to another aspect, the invention relates to a process for characterizing a flow generated in a device as defined above, said process comprising the following steps:
a) determining at least one dimension of the manufacturing area,
b) selecting modules from a given set of modules in order to form at least one of the first movement arm and the second movement arm of the modular robot so as to establish the total length of the first movement arm and/or the total length of the second movement arm according to the dimension determined in step a),
c) positioning the robot in the manufacturing chamber such that the measuring probe assumes a first position,
d) supplying gas to the manufacturing chamber so as to generate a shielding gas flow for the manufacturing area,
e) acquiring a first measurement of at least one physical variable indicative of the flow by means of the measuring probe,
f) moving the first chassis in translation along the first movement arm and/or the second chassis in translation along the second movement arm such that the measuring probe assumes a second position,
g) acquiring a second measurement of at least one physical variable by means of the measuring probe.

### BRIEF DESCRIPTION OF THE FIGURES

The invention will now be described in more detail by means of the single appended figure, which is given by way of nonlimiting illustration.

FIG. 1 schematically shows an installation for implementing an additive manufacturing process according to one embodiment of the invention.

FIG. 2 shows a three-dimensional view of a modular robot according to one embodiment of the invention.

FIG. 3 shows a top view of the robot according to FIG. 2.

FIG. 4 shows a three-dimensional view of a modular robot according to another embodiment of the invention.

FIG. 5 shows joining means for joining movement arm modules according to one embodiment of the invention.

FIG. 6 shows joining means for joining movement arm modules according to other embodiments of the invention.

### DETAILED DESCRIPTION OF THE INVENTION

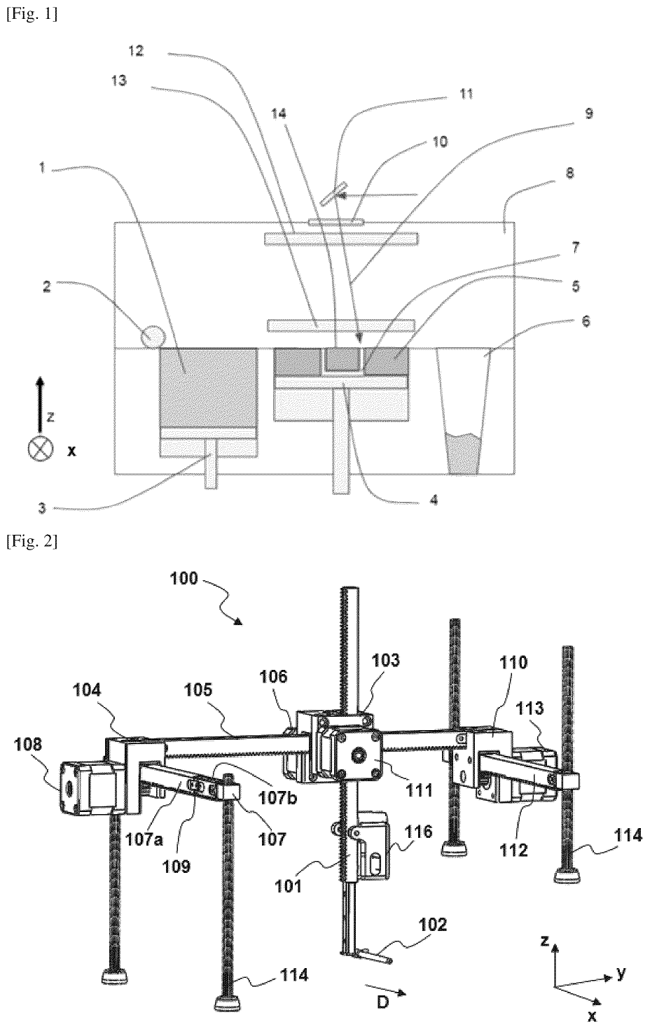

FIG. 1 shows an exemplary embodiment of an additive manufacturing process in a manufacturing chamber. The invention applies in particular to powder bed laser fusion. In this case, the means for irradiating the base material is a laser source. It is also possible to envisage using an electron beam as irradiation means.

During operation, a powder bed 14 forming the base material is melted by sweeping a laser beam 9 obtained using a head 11 or scanner, comprising for example an orientable return mirror. The head 11 is controlled by a digital command which orients the laser beam toward the areas of the powder bed 14 that are to be melted. The laser beam 9 can be generated by at least one laser source selected from a CO₂ laser, a fiber laser or a disk laser, a diode laser.

The device according to the invention comprises an enclosure referred to as manufacturing chamber 8. The chamber 8 is intended to contain a gaseous atmosphere which may be formed by an inert shielding gas such as argon or nitrogen. The shielding gas is distributed in the chamber by a gas supply system comprising one or more gas inlets. With preference, at least one gas inlet 13 distributes the shielding gas above the powder bed 14, preferably in a plane substantially orthogonal to the manufacturing direction z in which the layers of base material are deposited and melted in succession. The gas flow preferably flows in a flow direction x orthogonal to the direction z.

The shielding gas preferably comprises at least one inert constituent selected from argon, helium, nitrogen. The shielding gas may possibly contain additional constituents, for example carbon dioxide.

Advantageously, the chamber is equipped with a system for extracting fumes and sputter. This system is preferably arranged on a side of the chamber that is situated opposite the gas inlet 13. The flow direction x is oriented from the first orifice 13 toward at least one extraction orifice of the extraction system.

An orifice 12 preferably distributes the shielding gas below the protective window 10 so as to avoid the latter being fouled by the fumes from the layer melting operation.

The manufacture of the part preferably starts after a manufacturing chamber purging step for obtaining a gaseous atmosphere with an oxygen content of less than 0.1% by volume. The manufacturing chamber comprises sensors, for example of the electrochemical or zircon type, configured to measure the oxygen content in the manufacturing chamber and thus permit or halt the manufacturing.

While the part is being manufactured, the powder bed 14 is spread by a scraper 2 on a manufacturing platform 4. The powder is supplied by a tray 1 which rises by means of a piston 3. Excess powder falls into the reservoir 6.

After each layer has been manufactured, the manufacturing platform 4 is lowered, in a direction opposite the manufacturing direction z, from a height corresponding to the height of the new layer of powder deposited on the previous layer. After each layer has been deposited, the powder bed is selectively swept with the laser beam, according to the digital model determining the three-dimensional shape of the part. The layer of metal powder is melted selectively in a predefined manufacturing area corresponding to a cross section of the metal part to be manufactured, this cross section being orthogonal to the manufacturing direction z. The steps of depositing and melting the bed and of moving the platform are repeated at least once, until the construction of the part by superposition, in the direction z, of the various melted sections has finished. It will be noted that a new layer is deposited preferably after the previous layer has solidified. It should be noted that the powder is melted preferably in overall melting directions that are opposite the flow direction y.

An amount of non-melted powder 5 remains on the manufacturing platform 4, around the part 7 being manufactured. In general, the thickness of each manufactured layer ranges between 10 and 120 μm, depending on the quality and speed of manufacture of the part or parts to be realized. This layer thickness also depends on the grain size of the powders. The metal powder used is preferably formed of grains with a diameter ranging between 10 and 70 μm.

The base material 14 could for example be selected from alloyed steels, non-alloyed steels, in particular stainless steels, carbon steels, aluminum, aluminum alloys, nickel, nickel alloys, titanium, titanium alloys.

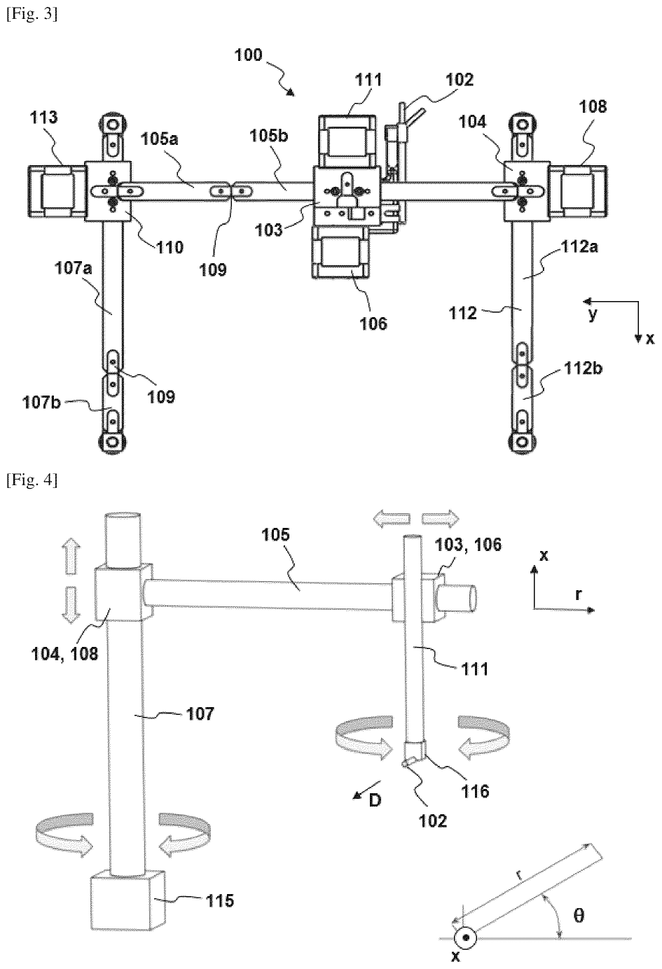

FIG. 2 illustrates a particular embodiment of a modular robot 100 configured to characterize at least one portion of a shielding gas flow generated in a manufacturing chamber 8. FIG. 3 is a top view of this robot. In this embodiment, the modular robot 100 is a Cartesian coordinate robot which can be moved along three axes parallel to the three directions x, y, z of a Cartesian coordinate system. During operation, the directions x, y are preferably comprised in a plane which is orthogonal to the direction z and which is parallel to the manufacturing area corresponding to a cross section of the part to be manufactured. The third direction z is preferably vertical.

Said modular robot 100 comprises a measuring arm 101 to which is fixed at least one measuring probe 102 configured to measure at least one physical variable characteristic of the gas flow. A first chassis 103 supports the measuring arm 101 and a first movement arm 105 is associated with the first chassis 103 and extends parallel to the first direction y. The robot 100 comprises first drive means 106 that are able to make the first chassis 103 move in translation along the first movement arm 105.

The robot 100 additionally comprises a second chassis 104 to which the first movement arm 105 is secured. A second movement arm 107 is associated with the second chassis 104 and extends parallel to a second direction x. Second drive means 108 make it possible to make the second chassis 104, and the first movement arm 105 secured to the first chassis, move in translation along the second movement arm 107, thus allowing the measuring arm 101 to move in the two directions x, y.

According to the invention, at least one of the first movement arm 105 and the second movement arm 107 of the modular robot 100 comprises multiple physically separate modules 105a, 105b, 107a, 107b joined one after another by removable joining means 109 such that the total length of the first movement arm 105 and/or the total length of the second movement arm 107 can be adjusted by removing or adding one or more modules 105a, 105b, 107a, 107b. For the first movement arm 105, the modules 105a, 105b are joined one after the one or more others in the first direction y. For the second movement arm 107, the modules 107a, 107b are joined one after the one or more others in the second direction x. The total length of the first arm 105, measured in the first direction y, corresponds to the sum of the individual lengths of the modules forming the first arm 105. The total length of the second arm 107, measured in the second direction x, corresponds to the sum of the individual lengths of the modules forming the second arm 107.

As a result, the length of the movement arms can be easily adapted to changes in dimensions of the chamber and/or of the flow area to be characterized. A robot designed for one chamber can be used in another chamber by modifying the number and/or the length of the modules forming the arm, and this affords greater flexibility and speed of adaptation, irrespective of the dimensions of the chamber and of the manufacturing area to be characterized.

With preference, each of the first movement arm 105 and second movement arm 107 of the modular robot 100 comprises multiple modules, and this affords adaptability in the two transverse directions of the chamber.

Advantageously, the modular robot 100 comprises third drive means 111 for the measuring arm 101. The third drive means 111 are secured to the first chassis 103 and are able to make the measuring arm 101 move in translation parallel to the third direction z. It is thus possible to make the measuring probe 102 move in a third dimension.

With preference, the modular robot 100 additionally comprises a third chassis 110 and a third movement arm 112 associated with the third chassis 110, the third movement arm 112 extending parallel to the second movement arm 107. The first movement arm 105 is fixed to the second chassis 104 at one end and to the third chassis 110 at the other end. Fourth drive means 113 are configured to make the third chassis 110 move in translation parallel to the third arm 112. This improves the robustness of the robot and the control of its movements. With preference, the robot 100 comprises means for synchronizing the second drive means 108 and fourth drive means 113 that are configured to synchronize the translational movement of the second chassis 104 and of the third chassis 110.

It will be noted that the third movement arm 112 and/or the measuring arm 101 are preferably also formed of multiple modules in order to adjust their lengths.

According to one possibility, the movement arms of the robot 100 are mounted on fixing feet 114 which are height-adjustable, which is to say make it possible to adjust the positioning of the movement arms of the robot in the third direction z.

In particular, each of the first 105, second 107 and/or third 112 movement arms and/or the measuring arm 101 of the modular robot 100 comprises from two to 40 modules, preferably from 2 to 10 modules. It should be noted that the measuring arm 101 may be formed of only one module.

In particular, the modules forming the first 105, second 107 and/or third 112 movement arms and/or the measuring arm 101 of the modular robot (100) have lengths ranging between 25 and 500 mm.

FIG. 4 illustrates a particular embodiment in which the modular robot 100 is a polar robot which can be moved in translation and in rotation in a cylindrical coordinate system x, r, θ. In particular, the modular robot 100 comprises fifth drive means 115, 108 that are able to make the second chassis 104 rotate about the second arm 107 or to make the second arm 107 rotate on itself. With preference, the first direction corresponds to the radial direction r and the second direction x corresponds to the vertical direction. The rotational movement of the first chassis 103 varies the angular positioning θ.

According to one possibility, which can be applied to the various embodiments of the invention, the robot 100 may comprise angular adjustment means 116 for angularly adjusting the positioning of the measuring probe 102 by way of pivoting on the first movement arm 105 and/or by way of rotation about the first movement arm 105. This makes it possible to be able to align the measuring probe 102 with the direction of the shielding gas flow.

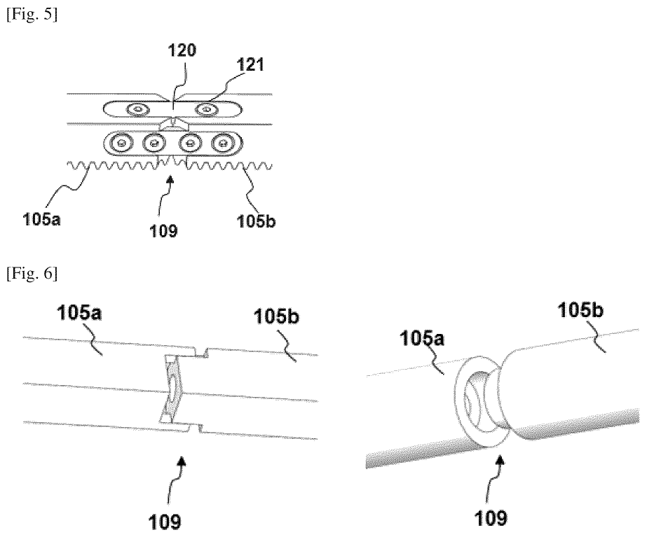

FIG. 5 and FIG. 6 illustrate possible embodiments of the removable joining means 109 for joining modules to one another. The joining means may comprise one or more intermediate parts 120 and securing means 121 for securing the intermediate part 120 to both one module 105a and to another module 105b. FIG. 5 shows an example of parts 120 in the form of clips 121 screwed to each of the arms. According to an alternative, the removable joining means 109 may be configured to join modules by push-fitting and/or by way of a magnetic connection. As an alternative or additionally, the joining means 109 may also comprise poka-yoke features.

According to one embodiment, the drive means of the modular robot 100 each comprise a motor interacting with a drive system for the associated chassis. The drive system may be a rack-and-pinion drive system. In this case, the movement arms have a toothed surface and form racks intended to mesh with a toothed pinion which is set in rotation by the motor. According to another possibility, the drive system may operate by friction. In this case, a pinion coated with a deformable material is set in rotation by the motor and interacts with the non-deformable surface of the associated movement arm by friction. It should be noted that the device according to the invention can utilize unipolar or bipolar stepper motors. It is also possible to envisage the use of DC motors.

The modular robot 100 is preferably configured to move in steps of at most 1 mm in one direction and/or the other direction. The movements may also be performed with smaller steps, typically ranging up to the steps of the motor used, in particular up to 0.02 mm.

Within the context of the invention, the measuring probe 102 may be any means able to measure a physical variable indicative of the homogeneity of the gas flow. With preference, the measuring probe 102 is configured to measure a volumetric flow rate and/or velocity of the gas flow, in particular the measuring probe 102 comprises a Pitot tube or a hot wire system.

It is also conceivable to equip the measuring arm 101 with at least one additional measuring probe configured to measure a temperature of and/or an oxygen content in the gas flow. The measuring probe 102 itself may also be configured to measure the flow velocity and another physical variable such as the temperature of and/or the oxygen content in the gas flow.

Advantageously, the device according to the invention comprises a control-and-command unit and means for transmitting command signals and measurement signals between the control-and-command unit and the modular robot 100. The control-and-command unit preferably comprises at least one of the following: a microcontroller, a microprocessor, a computer. The control-and-command unit is configured to control the movement of the modular robot 100 and to acquire measurements taken by the measuring probe 102. The transmission means may be wired or wireless, preferably by way of a WiFi connection or Bluetooth, or any other wireless protocol.

The drive means and the control-and-command unit are preferably supplied with power by a battery, and this makes the device autonomous. It is also possible to envisage connecting the device to the power grid, in order to perform longer-term flow characterizations.

The manufacturing area where the gas flow is to be characterized may have, in a plane corresponding to a cross-sectional plane of the part to be manufactured, characteristic dimensions ranging from 50 mm to 800 mm. The device according to the invention may be adapted to these various dimensions by virtue of the modularity of the movement arms.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing i.e. anything else may be additionally included and remain within the scope of “comprising.” “Comprising” is defined herein as necessarily encompassing the more limited transitional terms “consisting essentially of” and “consisting of”; “comprising” may therefore be replaced by “consisting essentially of” or “consisting of” and remain within the expressly defined scope of “comprising”.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-15. (canceled)

16. A device for additively manufacturing at least one part, comprising:
a manufacturing chamber with an internal volume, comprising a manufacturing area within the internal volume,
an irradiation means configured to irradiate at least part of the manufacturing area corresponding to a cross section of said part,
a gas supply system connected to the internal volume of the manufacturing chamber and configured to generate a shielding gas flow for the manufacturing area when gas is supplied to the manufacturing chamber,
a modular robot configured to utilize at least one portion of the shielding gas flow, said modular robot comprising:
a measuring arm comprising at least one measuring probe configured to measure at least one physical variable characteristic of the gas flow,
a first chassis supporting the measuring arm,
a first movement arm associated with the first chassis and extending parallel to a first direction (r, y),
a first drive means for the first chassis that are able to make the first chassis move in translation along the first movement arm,
a second chassis to which the first movement arm is secured,
a second movement arm associated with the second chassis and extending parallel to a second direction (x),
a second drive means for the second chassis that are able to make the second chassis and the first movement arm move in translation along the second movement arm,
wherein at least one of the first movement arm and the second movement arm of the modular robot comprises multiple physically separate modules joined to one another by removable joining means such that the total length of the first movement arm and/or the total length of the second movement arm can be adjusted by removing or adding one or more modules.

17. The device of claim 16, wherein the first direction (y, r) is orthogonal to the second direction (x).

18. The device of claim 16, wherein the modular robot comprises a third drive means for the measuring arm that are secured to the first chassis, the third drive means being able to make the measuring arm move in translation parallel to a third direction (z) orthogonal to the first direction (x).

19. The device of claim 16, wherein the modular robot further comprises a third chassis and a third movement arm associated with the third chassis, the third movement arm extending parallel to the second movement arm, the first movement arm being secured to the third chassis, the modular robot comprising fourth drive means for the third chassis that are capable of making the third chassis move in translation along the third movement arm and means for synchronizing the second drive means and the fourth drive means that are configured to synchronize the translational movement of the second chassis and of the third chassis.

20. The device of claim 16, wherein the modular robot comprises a fifth drive means capable of making the second chassis rotate about the second arm or to make the second arm rotate on itself.

21. The device of claim 16, wherein the robot comprises an angular adjustment means that are configured to adjust the positioning of the measuring probe by way of pivoting on the first movement arm and/or by way of rotation about the first movement arm.

22. The device of claim 16, wherein the removable joining means for joining one module to another comprise at least one intermediate part and securing means for securing said intermediate part to both one module and the other module.

23. The device of claim 16, wherein the removable joining means are configured to join one module to another by push-fitting and/or by way of a magnetic connection.

24. The device of claim 16, wherein each of the first, second and/or third movement arms and/or the measuring arm of the modular robot comprises from 2 to 40 modules.

25. The device of claim 16, wherein the modules forming the first, second and/or third movement arms and/or the measuring arm of the modular robot have lengths ranging between 25 and 500 mm.

26. The device of claim 16, wherein each of the first, second, third, fourth and/or fifth drive means comprises a motor interacting with a rack-and-pinion drive system, the one or more movement arms having a toothed surface intended to mesh with a toothed pinion, or a friction drive system comprising a pinion coated with a deformable material frictionally interacting with the one or more movement arms.

27. The device of claim 16, wherein the measuring probe is configured to measure a volumetric flow rate and/or velocity of the gas flow.

28. The device of claim 16, wherein the measuring arm comprises at least one additional measuring probe configured to measure a temperature of and/or an oxygen content in the gas flow or the measuring probe is configured to measure a temperature of and/or an oxygen content in the gas flow.

29. The device of claim 16, wherein it is configured for powder-bed laser fusion additive manufacturing, the device comprising:
a manufacturing platform configured to receive the base material in the form of a layer of metal powder, a manufacturing direction z in which the layers of base material are deposited and melted in succession,
spreading means for spreading said layer so as to form a powder bed extending in a plane orthogonal to a manufacturing direction (z),
at least one laser source configured to irradiate and selectively melt the powder bed in the manufacturing area corresponding to a cross section of the metal part,
means for moving the manufacturing platform parallel to the manufacturing direction (z).

30. A process for utilizing a flow generated in a device as defined by one of the preceding claims, said process comprising the following steps:
a) determining at least one dimension of the manufacturing area,
b) selecting modules from a given set of modules in order to form at least one of the first movement arm and the second movement arm of the modular robot so as to establish the total length of the first movement arm and/or the total length of the second movement arm according to the dimension determined in step a),
c) positioning the robot in the manufacturing chamber such that the measuring probe assumes a first position,
d) supplying gas to the manufacturing chamber so as to generate a shielding gas flow for the manufacturing area,
e) acquiring a first measurement of at least one physical variable indicative of the flow by means of the measuring probe,
f) moving the first chassis in translation along the first movement arm and/or the second chassis in translation along the second movement arm such that the measuring probe assumes a second position,
g) acquiring a second measurement of at least one physical variable by means of the measuring probe.
